(19) United States
(12) Patent Application Publication
(10) Pub. No.: US 2013/0346926 A1
(43) Pub. Date: Dec. 26, 2013

(54) Automatic optimal integrated circuit generator from algorithms and specification

(71) Applicant: ALGOTOCHIP CORPORATION, Sunnyvale, CA (US)

(72) Inventors: Anand Pandurangan, Sunnyvale, CA (US); Satish Padmanabhan, Sunnyvale, CA (US); Siva Selvaraj, Sunnyvale, CA (US); Shailesh I. Shah, Folsom, CA (US); Krishna Kumar Gadiyaram, Sunnyvale, CA (US); Gagan Bihari Rath, Santa Clara, CA (US); Fuk Ho Pius Ng, Hillsboro, OR (US); Ananth Durbha, San Jose, CA (US); Suresh Kadiyala, Cupertino, CA (US)

(73) Assignee: ALGOTOCHIP CORPORATION, Sunnyvale, CA (US)

(21) Appl. No.: 13/672,822

(22) Filed: Nov. 9, 2012

Related U.S. Application Data
(63) Continuation-in-part of application No. 12/835,621, filed on Jul. 13, 2010, now Pat. No. 8,370,784.

(51) Int. Cl. G06F 17/50

(52) U.S. Cl. CPC G06F 17/5045
USPC 716/102; 716/132

(57) ABSTRACT

Systems and methods are disclosed to automatically design a custom integrated circuit based on algorithmic process or code as input and using highly automated tools that requires virtually no human involvement is disclosed.

### CROSS-REFERENCED APPLICATIONS

This application is a continuation-in-part of application Ser. No. 12/835,621 entitled “AUTOMATIC OPTIMAL INTEGRATED CIRCUIT GENERATOR FROM ALGORITHMS AND SPECIFICATION”, which is related to commonly owned, concurrently filed application Ser. No. 12/835,603 entitled “AUTOMATIC OPTIMAL INTEGRATED CIRCUIT GENERATOR FROM ALGORITHMS AND SPECIFICATION”, application Ser. No. 12/835,628 entitled “APPLICATION DRIVEN POWER GATING”, application Ser. No. 12/835,631 entitled “SYSTEM, ARCHITECTURE AND MICRO-ARCHITECTURE (SAMA) REPRESENTATION OF AN INTEGRATED CIRCUIT”, and application Ser. No. 12/835,640 entitled “ARCHITECTURAL LEVEL POWER-AWARE OPTIMIZATION AND RISK MITIGATION”, the contents of which are incorporated by reference.

### BACKGROUND

The present invention relates to a method for designing a custom integrated circuit or an application-specific integrated circuit (ASIC).

Modern electronic appliances and industrial products rely on electronic devices such as standard and custom integrated circuits (ICs). An IC designed and manufactured for specific purposes is called an ASIC. The number of functions, which translates to transistors, included in each of those ICs has been rapidly growing year after year due to advances in semiconductor technology. Reflecting such trends, methods of designing ICs have been changing. In the past, an IC used to be designed as a mere combination of a number of general-purpose ICs. Recently, however, the designer needs to create his or her original IC such that the IC can perform any function as required. In general, unit costs and sizes are decreasing while design functionality is increasing.

Normally the chip design process begins when algorithm designers specify all the functionality that the chip must perform. This is usually done in a language like C or Matlab. Then it takes a team of chip specialists, tools engineers, verification engineers and firmware engineers many man-years to map the algorithm to a hardware chip and associated firmware. This is a very expensive process and also fraught with lot of risks.

Today's designs are increasingly complex, requiring superior functionality combined with constant reductions in size, cost and power. Power consumption, signal interactions, advancing complexity, and worsening parasitics all contribute to more complicated chip design methodology. Design trends point to even higher levels of integration, with transistor counts exceeding millions of transistors for digital designs. With current technology, advanced simulation tools and the ability to reuse data are falling behind such complex designs.

Developing cutting-edge custom IC designs has introduced several issues that need to be resolved. Higher processing speeds have introduced conditions into the analog domain that were formerly purely digital in nature, such as multiple clock regions, increasingly complex clock multiplication and synchronization techniques, noise control, and high-speed I/O. Impediments occur in the design and verification cycle because design complexity continues to increase while designers have less time to bring their products to market, resulting in reduced amortization for design costs. Another effect of increased design complexity is the additional number of production turns that may be needed to achieve a successful design. Yet another issue is the availability of skilled workers. The rapid growth in ASIC circuit design has coincided with a shortage of skilled IC engineers.

### SUMMARY

In one aspect, a method to automatically design a custom integrated circuit based on algorithmic process or code as input and using highly automated tools that requires virtually no human involvement is disclosed.

The method includes receiving a specification of the custom integrated circuit including computer readable code and one or more constraints on the custom integrated circuit; automatically generating a computer architecture for the computer readable code that best fits the constraints; automatically determining an instruction execution sequence based on the code profile and reassigning or delaying the instruction sequence to spread operation over one or more processing blocks to reduce hot spots; continuously evaluating and optimizing one or more factors including physical implementation, and local and global area, timing, or power at an architecture level above RTL or gate-level synthesis; automatically generating a software development kit (SDK) and the associated firmware automatically to execute the computer readable code on the custom integrated circuit; automatically generating associated test suites and vectors for the computer readable code on the custom integrated circuit; and automatically synthesizing the designed architecture and generating a computer readable description of the custom integrated circuit for semiconductor fabrication.

In another aspect, a method to automatically design a custom integrated circuit with minimal human involvement includes receiving a specification of the custom integrated circuit including computer readable code and one or more constraints on the custom integrated circuit; automatically devising a processor architecture and generating a processor chip specification uniquely customized to the computer readable code which satisfies the constraints; and synthesizing the chip specification into a layout of the custom integrated circuit. This aspect is also performed using highly automated tools that require virtually no human involvement.

Implementations of the above aspects may include one or more of the following. The system includes performing static profiling of the computer readable code and/or dynamic profiling of the computer readable code. A system chip specification is designed based on the profiles of the computer readable code. The chip specification can be further optimized incrementally based on static and dynamic profiling of the computer readable code. The computer readable code can be compiled into optimal assembly code, which is linked to generate firmware for the selected architecture. A simulator can perform cycle accurate simulation of the firmware. The system can perform dynamic profiling of the firmware. The method includes optimizing the chip specification further based on profiled firmware or based on the assembly code. The system can automatically generate register transfer level (RTL) code for the designed chip specification. The system can also perform synthesis of the RTL code to fabricate silicon.

Advantages of the preferred embodiments of the system may include one or more of the following. The system alleviates the problems of chip design and makes it a simple process. The embodiments shift the focus of product development process back from the hardware implementation process back to product specification and computer readable code or algorithm design. Instead of being tied down to specific hardware choices, the computer readable code or algorithm can be implemented on a processor that is optimized specifically for that application. The preferred embodiment generates an optimized processor automatically along with all the associated software tools and firmware applications. This process can be done in a matter of days instead of years as is conventional. The system is a complete shift in paradigm in the way hardware chip solutions are designed.

The instant system removes the risk and makes chip design an automatic process so that the algorithm designers themselves can directly make the hardware chip without any chip design knowledge. The primary input to the system would be the computer readable code or algorithm specification in higher-level languages like C or Matlab.

Of the many benefits, the benefits of using the system may include
1) Schedule: If chip design cycles become measured in weeks instead of years, the companies using The instant system can penetrate rapidly changing markets by bringing their products quickly to the market.
2) Cost: The numerous engineers that are usually needed to be employed to implement chips are made redundant. This brings about tremendous cost savings to the companies using The instant system.
3) Optimality: The chips designed using The instant system product have superior performance, Area and Power consumption.

The instant system is a complete shift in paradigm in methodology used in design of systems that have a digital chip component to it. The system is a completely automated software product that generates digital hardware from algorithms described in C/Matlab. The system uses a unique approach to the process of taking a high level language such as C or Matlab to realizable hardware chip. In a nutshell, it makes chip design a completely automated software process.

### BRIEF DESCRIPTION OF THE DRAWINGS

FIG. 1 shows an exemplary system to automatically generate a custom IC.

FIG. 2 shows an exemplary workflow to automatically generate a custom IC.

FIG. 3 shows an exemplary process to automatically generate a custom IC.

FIG. 4 shows an exemplary C code profile.

FIG. 5 shows a base level chip specification.

FIG. 6 shows a first architecture from the chip specification of FIG. 5.

FIG. 7 shows a second architecture from chip specification of FIG. 5.

FIG. 8 shows one exemplary system for automatic IC fabrication, while FIG. 9 shows more details the system of FIG. 8.

### DESCRIPTION

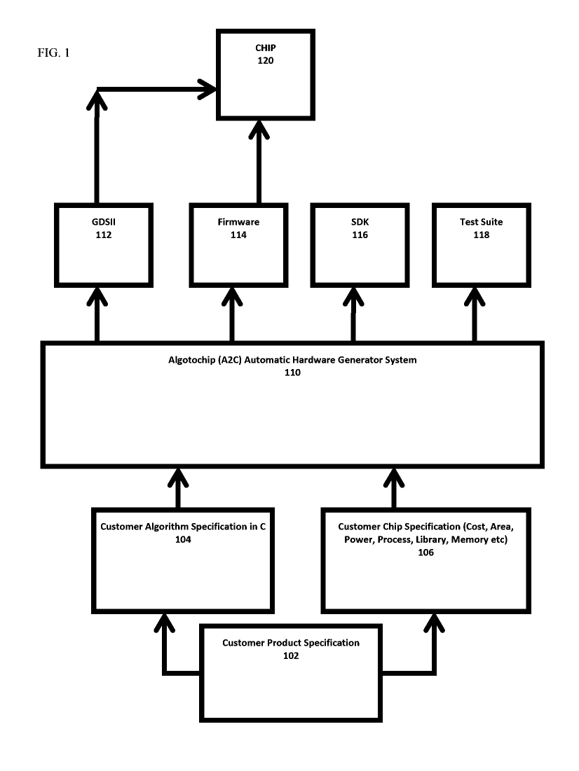

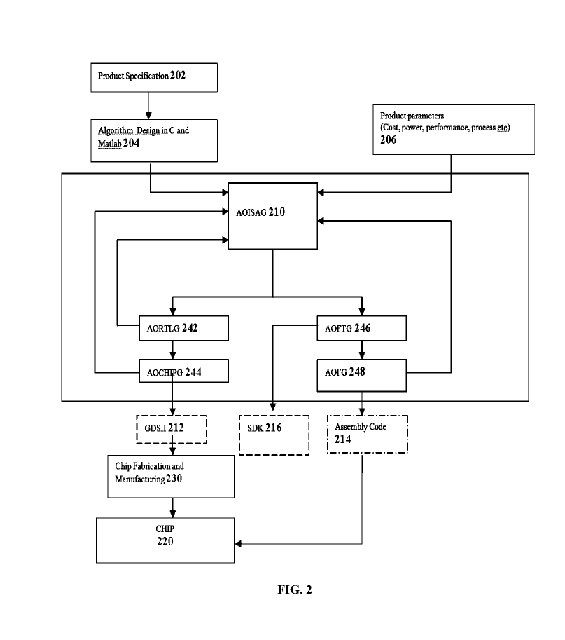

FIG. 1 shows an exemplary system to automatically generate a custom IC. The system of FIG. 1 supports an automatic generation of the optimal custom integrated circuit solution for the chosen target application. The target application specification is usually done through algorithm expressed as computer readable code in a high-level language like C, Matlab, SystemC, Fortran, Ada, or any other language. The specification includes the description of the target application and also one or more constraints such as the desired cost, area, power, speed, performance and other attributes of the hardware solution.

In FIG. 1, an IC customer generates a product specification 102. Typically there is an initial product specification that captures all the main functionality of a desired product. From the product, algorithm experts identify the computer readable code or algorithms that are needed for the product. Some of these algorithms might be available as IP from third parties or from standard development committees. Some of them have to be developed as part of the product development. In this manner, the product specification 102 is further detailed in a computer readable code or algorithm 104 that can be expressed as a program such as C program or a math model such as a Matlab model, among others. The product specification 102 also contains requirements 106 such as cost, area, power, process type, library, and memory type, among others.

The computer readable code or algorithm 104 and requirement 106 are provided to an automated IC generator 110. Based only on the code or algorithm 104 and the constraints placed on the chip design, the IC generator 110 uses the process of FIG. 2 to automatically generate with no human involvement an output that includes a GDS file 112, firmware 114 to run the IC, a software development kit (SDK) 116, and/or a test suite 118. The GDS file 112 is used to fabricate a custom chip 120. The firmware 114 is then run on this fabricated chip to implement the customer product specification 102

The instant system alleviates the issues of chip design and makes it a simple process. The system shifts the focus of product development process back from the hardware implementation process back to product specification and algorithm design. Instead of being tied down to specific hardware choices, the algorithm can always be implemented on a digital chip processor that is optimized specifically for that application. The system generates this optimized processor automatically along with all the associated software tools and firmware applications. This whole process can be done in a matter of days instead of years that it takes now. In a nutshell the system makes the digital chip design portion of the product development in to a black box.

In one embodiment, the instant system product can take as input the following:

Computer readable code or algorithm defined in C/Matlab

Peripherals required

IO Specification

Area Target

Power Target

Margin Target (how much overhead to build in for future firmware updates and increases in complexity)

Process Choice

Standard Cell library Choice

Memory compiler Choice

Testability (scan, tap controller, bist etc)

The output of the system may be a Digital Hard macro along with all the associated firmware. A software development kit (SDK) optimized for this Digital Hard macro is also automatically generated so that future upgrades to firmware are implemented without having to change the processor.

FIG. 2 shows an exemplary workflow to automatically generate a custom IC. This system performs automatic generation of the complete and optimal hardware solution for any chosen target application. While the common target applications are in the embedded applications space they are not necessarily restricted to that.

Referring to FIG. 2, an ASIC customer generates a product specification 202. The product specification 202 is further detailed in a computer readable code or algorithm 204 that can be expressed as a program such as C program or a math model such as a Matlab model, among others. The product specification 202 also contains product parameters and requirements 206 such as cost, area, power, process type, library, and memory type, among others. The computer readable code or algorithm 204 and product parameters 206 are provided to an automated IC generator 110 including an Automatic Optimal Instruction Set Architecture Generator (AOISAG) (210). The generator 210 controls an Automatic Optimal RTL Generator (AORTLG) 242, which drives an Automatic Optimal Chip Generator (AOCHIPG) 244. The output of AOCHIPG 244 and AORTLG 242 is provided in a feedback loop to the AOISAG 210. The AOISAG 210 also controls an Automatic Optimal Firmware Tools Generator (AOFTG) 246 whose output is provided to an Automatic Optimal Firmware Generator (AOFG) 248. The AOFG 248 output is also provided in a feedback loop to the AOISAG.

The IC generator 110 generates as output a GDS file 212, firmware 214 to run the IC, a software development kit (SDK) 216. The GDS file 212 and firmware 214 are provided to an IC fabricator 230 such as TSMC or UMC to fabricate a custom chip 220.

In one embodiment, the system is completely automated. No manual intervention or guidance is needed. The system is optimized. The tool will automatically generate the optimal solution. In other embodiments, the user can intervene to provide human guidance if needed.

The AOISAG 210 can automatically generate an optimal instruction set architecture (called ISA). The ISA is defined to be every single detail that is required to realize the programmable hardware solution and encompasses the entire digital chip specification. The details can include one or more of the following exemplary factors:

1) Instruction set functionality, encoding and compression

2) Co-processor/multi-processor architecture

3) Scalarity

4) Register file size and width. Access latency and ports

5) Fixed point sizes

6) Static and dynamic branch prediction

7) Control registers

8) Stack operations

9) Loops

10) Circular buffers

11) Data addressing

12) Pipeline depth and functionality

13) Circular buffers

14) Peripherals

15) Memory access/latency/width/ports

16) Scan/tap controller

17) Specialized accelerator modules

18) Clock specifications

19) Data Memory and Cache system

20) Data pre-fetch Mechanism

21) Program memory and cache system

22) Program pre-fetch mechanism

The AORTLG 242 is the Automatic Optimal RTL Generator providing an automatic generation of the hardware solution in Register Transfer Language (RTL) from the optimal ISA. The AORTLG 242 is completely automated. No manual intervention or guidance is needed. The tool will automatically generate the optimal solution. The RTL generated is synthesizable and compilable.

The AOCHIPG 244 is the Automatic Optimal Chip Generator that provides automatic generation of the GDSII hardware solution from the optimal RTL. The tool 244 is completely automated. No manual intervention or guidance is needed. The tool will automatically generate the optimal solution. The chip generated is completely functional and can be manufactured using standard FABs without modification.

The AOFTG 246 is the Automatic Optimal Firmware Tools Generator for an automatic generation of software tools needed to develop firmware code on the hardware solution. It is completely automated. No manual intervention or guidance is needed. The tool will automatically generate the optimal solution. Standard tools such as compiler, assembler, linker, functional simulator, cycle accurate simulator can be automatically generated based on the digital chip specification. The AOFG 248 is the Automatic Optimal Firmware Generator, which performs the automatic generation of the firmware needed to be executed by the resulting chip 120. The tool is completely automated. No manual intervention or guidance is needed. Additionally, the tool will automatically generate the optimal solution. An optimized Real Time Operating System (RTOS) can also be automatically generated.

The chip specification defines the exact functional units that are needed to execute the customer application. It also defines exactly the inherent parallelism so that the number of these units that are used in parallel is determined. All the complexity of micro and macro level parallelism is extracted from the profiling information and hence the chip specification is designed with this knowledge. Hence the chip specification is designed optimally and not over designed or under-designed as such could be the case when a chip specification is designed without such profiling information.

During the dynamic profiling the branch statistics are gathered and based on this information the branch prediction mechanism is optimally designed. Also all the dependency checks between successive instructions are known from the profiling and hence the pipeline and all instruction scheduling aspects of the chip specification are optimally designed.

The chip specification can provide options such as:
Hardware modulo addressing, allowing circular buffers to be implemented without having to constantly test for wrapping.
Memory architecture designed for streaming data, using DMA extensively and expecting code to be written to know about cache hierarchies and the associated delays.
Driving multiple arithmetic units may require memory architectures to support several accesses per instruction cycle
Separate program and data memories (Harvard architecture), and sometimes concurrent access on multiple data busses
Special SIMD (single instruction, multiple data) operations
Some processors use VLIW techniques so each instruction drives multiple arithmetic units in parallel
Special arithmetic operations, such as fast multiply-accumulates (MACS).
Bit-reversed addressing, a special addressing mode useful for calculating FFTs
Special loop controls, such as architectural support for executing a few instruction words in a very tight loop without overhead for instruction fetches or exit testing
Special Pre-fetch instructions coupled with Data pre-fetch mechanism so that the execution units are never stalled for lack of data. So the memory bandwidth is designed optimally for the given execution units and the scheduling of instructions using such execution units.
Optimal Variable/Multi-Discrete length instruction encoding to get optimal performance and at the same time achieve very compact instruction footprint for the given application.

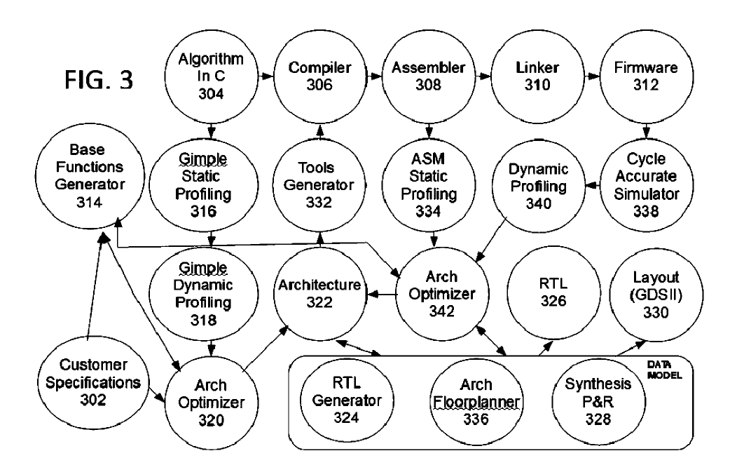

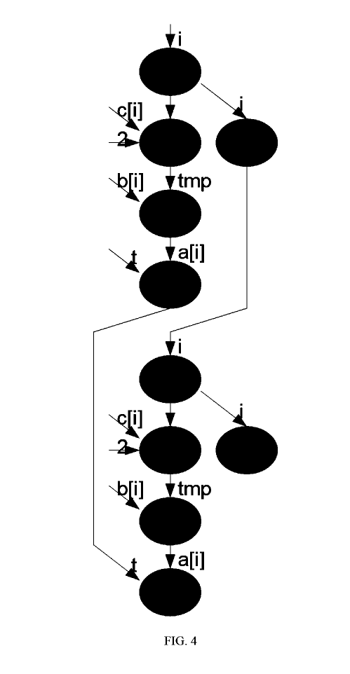

FIG. 3 shows an exemplary process flow for automatically generating the custom chip 120 of FIG. 1. Turning now to FIG. 3, a customer product specification is generated (302). The customer product specification 302 is further detailed in a computer readable code or algorithm 304 that can be expressed as a program such as C program or a math model such as a Matlab model, among others.

The customer algorithm 304 is profiled statically 316 and dynamically 318. The statistics gathered from this profiling is used in the architecture optimizer unit 320. This unit also receives the customer specification 302. The base functions generator 314 decides on the basic operations or execution units that will be needed to implement the customer algorithm 304. The base function generators 314 output is also fed to the architecture optimizer 320. The architecture optimizer 320, armed with the area, timing, and power information from base function generators along with internal implementation analysis to minimize area, timing, and power.

Based on the architecture optimizer 320 outputs and initial chip specification is defined as the architecture 322. This is then fed to the tools generator 332 unit to automatically generate the compiler 306, the Assembler 308, the linker 310, the cycle accurate simulator 338. Then using the tools chain the customer algorithm 304 is converted to firmware 312 that can run on the architecture 322.

The output of the assembler 308 is profiled statically 334 and the output of the cycle accurate simulator 338 is profiled dynamically 340. These profile information is then used by the architecture optimizer 342 to refine and improve the architecture 322.

The feedback loop from 322 to 332 to 306 to 308 to 310 to 312 to 338 to 340 to 342 to 322 and the feedback loop from 322 to 332 to 306 to 308 to 334 to 342 to 322 is executed repeatedly till the customer specifications are satisfied. These feedback loops happen automatically with no human intervention and hence the optimal solution is arrived at automatically.

The architecture optimizer 342 also is based on the architecture floor-planner 336 and synthesis and P&R 328 feedback. Architecture decisions are made in consultation with not only the application profiling information but also the physical place and route information. The architecture optimization is accurate and there are no surprises when the backend design of the designed architecture takes place. For example if the architecture optimizer chooses to use a multiplier unit that takes two 16 bit operands as input and generates a 32 bit result. The architecture optimizer 342 knows the exact timing delay between the application of the operands and the availability of the result from the floor-planner 336 and the synthesis 328. The architecture optimizer 342 also knows the exact area when this multiplier is placed and routed in the actual chip. So the architecture decision for using this multiplier is not only based on the need of this multiplier from the profiling data, but also based on the cost associated with this multiplier in terms of area, timing delay (also called performance) and power.

In another example, to speed up the performance if performance is a constraint on the custom chip, the compiler 306 takes a program, code or algorithm that takes long time to run on a serial processor, and given a new architecture containing multiple processing units that can operate concurrently the objective is to shorten the running time of the program by breaking it up into pieces that can be processed in parallel or in overlapped fashion in multiprocessing units. An additional task of front end is to look for parallelism and that of back end is to schedule it in such a manner that correct result and improved performance is obtained. The system determines what kind of pieces a program should be divided into and how these pieces may be rearranged. This involves
granularity, level, and degree of parallelism
analysis of the dependencies among the candidates of parallel execution.

In another example, if space or power is a constraint on the custom chip, the compiler would generate a single low power processor/DSP that executes the code sequentially to save power and chip real estate requirement, for example.

From the architecture block 322, the process can generate RTL using an RTL generator (324). RTL code is generated (326) and the RTL code can be provided to a synthesis placement and routing block (328). Information from an architecture floor planner can also be considered (336). The layout can be generated (330). The layout can be GDSII file format, for example.

One aspect of the invention also is the unified architecture 322 representation that is created so that both the software tools generator 332 and the hardware RTL generator 324 can use this representation. This representation is called as SAMA (system, architecture and micro-architecture).

The architecture design operation is based on analyzing the program, code or algorithm to be executed by the custom chip. In one implementation, given a program that takes long time to run on a uniscalar processor the system can improve performance by breaking the processing requirement into pieces that can be processed in parallel or in overlapped fashion in multiprocessing units. Additional task of front end is to look for parallelism and that of back end is to schedule it in such a manner that correct result and improved performance is obtained. The system can determine what kind of pieces a program should be divided into and how these pieces may be rearranged. This involves granularity, degree of parallelism, as well as an analysis of the dependencies among the candidates of parallel execution. Since program pieces and the multiple processing units come in a range of sizes, a fair number of combinations are possible, requiring different compiling approaches.

For these combinations the chip specification is done in such a way that the data bandwidth that is needed to support the compute units is correctly designed so that there is no over or under design. The Architecture Optimizer 342 first identifies potential parallel units in the program then performs dependency analysis on them to find those segments which are independent of each other and can be executed concurrently.

The architecture optimizer 342 identifies parallelism at granularity level of machine instruction. For example addition of two N-element vectors on an ordinary scalar processor will execute one instruction at a time. But on a vector processor all N instructions can be executed on N separate processor which reduces the total time to slightly more than N times that needed to execute a single addition. The architecture optimizer takes the sequential statements equivalent to the vector statement and performs a translation into vector machine instruction. The condition that allows vectorization is that the elements of the source operands must be independent of the result operands. For example, in the code:

```
DO 100 J = 1,N
      DO 100 I = 1,N
            DO 100 K = 1,N
                  C(I,J) = C(I,J) + A(I,K) * B(K,J)
100 CONTINUE
```

In this matrix multiplication example at each iteration CUM is calculated using previous value of CUM calculated in previous iteration so vectorization is not possible. If performance is desired, the system transforms the code into:

```
DO 100 J = 1,N
      DO 100 K = 1,N
            DO 100 I = 1,N
                  C(I,J) = C(I,J) + A(I,K) * B(K,J)
100 CONTINUE
```

In this case vectorization is possible because consecutive instructions calculate C(I−1,J) and C(I,J) which are independent of each other and can be executed concurrently on different processors. Thus dependency analysis at instruction level can help to recognize operand level dependencies and apply appropriate optimization to allow vectorization.

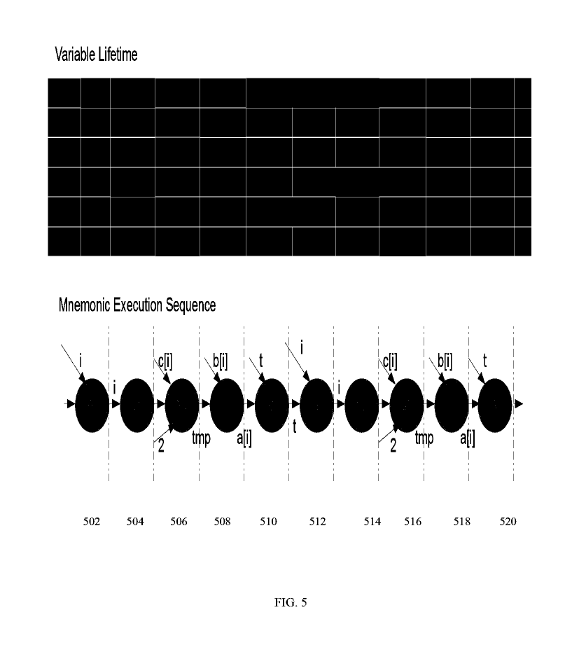

FIGS. 4-6 show an exemplary process for performing custom chip specification design for the following algorithm expressed as C code:

```
for (i=0; i < ilimit; i++) {
  a[i] = b[i] + 2 * c[i];
  t = t + a[i];
  }
```

FIG. 4 shows an exemplary static profiling using the gimple static profiling. In profiling, a form of dynamic program analysis (as opposed to static code analysis), investigates a program's behavior using information gathered as the program executes. The usual purpose of this analysis is to determine which sections of a program to optimize—to increase its overall speed, decrease its memory requirement or sometimes both. A (code) profiler is a performance analysis tool that, most commonly, measures only the frequency and duration of function calls, but there are other specific types of profilers (e.g. memory profilers) in addition to more comprehensive profilers, capable of gathering extensive performance data.

In the example of FIG. 4, the C code is reduced to a series of two operand operations. Thus, the first four operations perform a[i]=b[i]+2*c[i]+t, and in parallel the last four operations perform a[i]=b[i]+2*c[i]+t for the next value of i and the result of both groups are summed in the last operation.

FIG. 5 shows a simple base level chip specification to implement the above application. Each variable i, a[i], b[i], c[i], t, and tmp are characterized as being read or written. Thus, at time 502, i is read and checked against a predetermined limit. In 504, I in incremented and written, while c[i] is fetched. In 506, b[i] is read while a tmp variable is written to store the result of 2*c[i] and read from to prepare for next operation. In 508, a[i] is written to store the result of tmp added to b[i], and t is retrieved. In 510, t is written to store the result of the addition in 508, and i is read. From 512-520, the sequence in 502-510 is repeated for the next i.

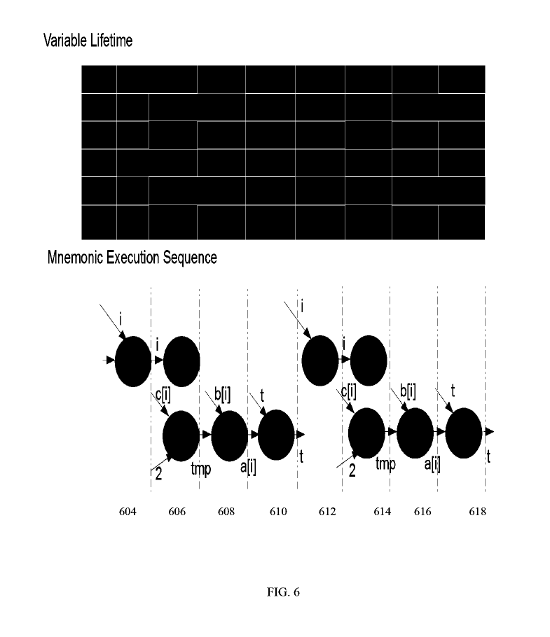

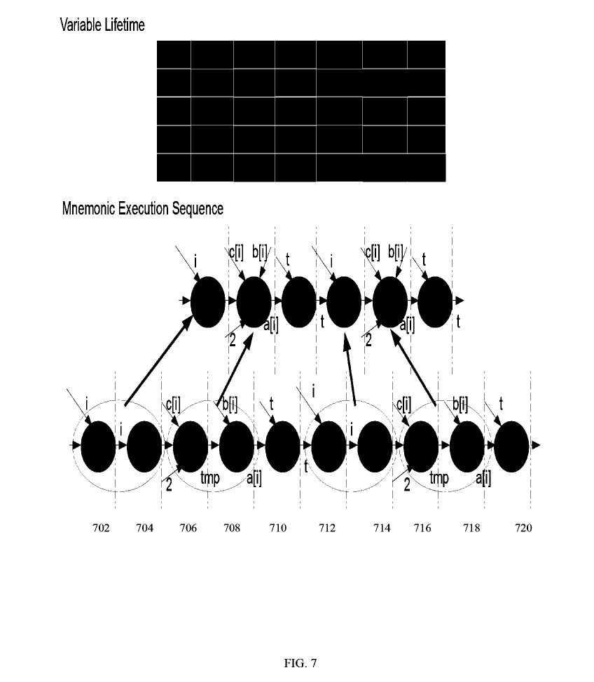

FIG. 6 shows a first architecture from the base line architecture of FIG. 5. In 604, variables I and c[i] are read. In 606, i is incremented and the new value is stored. B[i] is read, while tmp stores the result of 2*c[i] and then read for next operation. In 608, b[i] is added to tmp and stored in a[i], and the new a[i] and t are read for next operation. In 610, t is added to a[i], and the result is stored in t. In 612-618, a similar sequence is repeated for the next value of i.

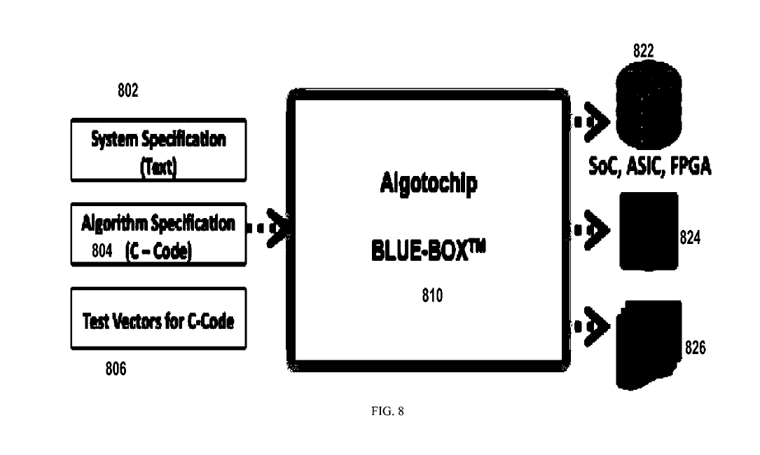

FIG. 7 shows a second architecture from the base line architecture of FIG. 5. In this architecture, the architecture optimizer detects that operations 702 and 704 can be combined into one operation with a suitable hardware. This hardware can also handle operations 706-708 in one operation. As a result, using the second architecture, i is checked to see if it exceeds a limit, and auto-incremented in one operation. Next, operations 706-708 are combined into one operation to do 2*c[i]+b[i] and storing the result as a[i]. In the third operation, t is added to a[i]. A similar 3 operation is performed for the next value of i.

The second architecture leverages knowledge of the hardware with auto-increment operation and multiply-accumulate operation to do several transactions in one step. Thus, the system can optimize for performance to the architecture.

Since program pieces and the multiple processing units come in a range of sizes, a fair number of combinations are possible, requiring different optimizing approaches. The architecture optimizer first identifies potential parallel units in the program then performs dependency analysis on them to find those segments which are independent of each other and can be executed concurrently.

Another embodiment of the concurrent optimization allowed in such system is the mitigation of Voltage Drop/IR Hot Spots. The process associates every machine instruction with an associated hardware execution path, which is a collection of on-chip logic and interconnect structures. The execution path can be thought of as the hardware “foot-print” of the instruction. The data model maintains a record of all possible execution paths and their associated instructions. The data model receives a statistical profile of the various machine instructions and extracts from this a steady state probability that an instruction is executed in any given cycle. The data model can create an estimated topological layout for each instruction execution path. Layout estimation is performed using a variety of physical design models based on a predetermined protocol to select the appropriate level of abstraction needed for the physical design modeling. The data model associates instructions' steady state probability of execution to the topology of its execution path. The data model creates sub-regions of the layout and for each sub-region there is a collection of intersecting execution paths which yields a collection of execution path probabilities which is used to compute a sub-region weight. The sub-region weight distribution (over the entire region) is used to estimate power hot-spot locations. The data model identifies impacted instructions whose execution paths intersect power hot-spots. Power hot-spot regions are then modeled as virtual restricted capacity resources. The data model arranges for scheduler to see the impacted instructions as dependent on the restricted capacity resources. Restricted capacity translates to limiting the number of execution paths in a sub-region that should be allowed to activate in close succession. Such a resource dependency can be readily added to resource allocation tables of a scheduler. The scheduler optimization will then consider the virtual resources created above in conjunction with other performance cost functions. Thus power and performance are simultaneously optimized. The system can generate functional block usage statistics from the profile. The system can track usage of different processing blocks as a function of time. The system can speculatively shut down power for one or more processing blocks and automatically switch power on for turned off processing blocks when needed. An instruction decoder can determine when power is to be applied to each power domain. Software tools for the custom IC to run the application code can be automatically generated. The tools include one or more of: Compiler, Assembler, Linker, Cycle-Based Simulator. The tool automatically generates firmware. The tools can profile the firmware and providing the firmware profile as feedback to optimizing the architecture. The instruction scheduler of the compiler can arrange the order of instructions, armed with this power optimization scheme, to maximize the benefit. The system anticipates the physical constraints and effects by estimation and virtually constructing the physical design with only architectural abstract blocks. In one example, it is possible to construct a floor plan based on a set of black boxes of estimated area. Having such construction at architecture level allows the system to consider any congestion, timing, area, etc. before the realization of RTL. In another example, certain shape or arrangement of black boxes may yield better floor plan and therefore, better timing, congestion, etc. Thus, it provides the opportunities to mitigate these issues at architecture level itself. Analogy to the physical world, an architect may consider how a house functions by considering the arrangement of different rooms without knowing the exact dimensions of aspect ratio, nor the content of the rooms.

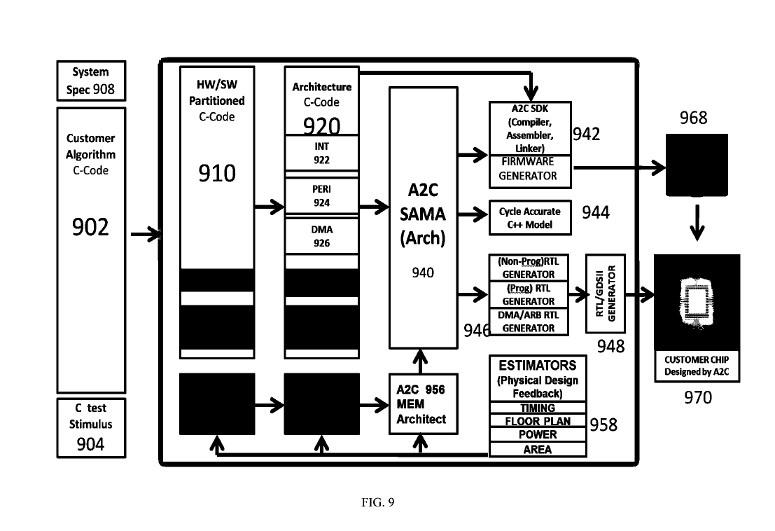

FIG. 8 shows a system 810 for automatic IC fabrication. The system 810 receives system specification text 802, algorithm or code specification 804, and test vectors for the code 806. One embodiment provides a complete C-code to GDSII solution for SoCs, ASICs, FPGA blocks 822 or IP Blocks that covers all aspects of hardware and software design in as little as eight weeks, including the enabling on-chip firmware and a software-development kit (SDK) 824 and documentation 826 to realize the customer's application. The generated SoC meets all the performance specifications made by the customer, and insures that it will be right the first time. The full ANSI C-code may be used by the customer to describe their Algorithm. This requires only a behavioral description—all timing-level performance and latency requirements are met by the system design flow, which keeps its customers in-the-loop right up to deliver of finished chips.

The system 810 completely replaces a customer's traditional chip development efforts with a turnkey solution. Blue-Box generates a complete foundry-ready SoC, ASIC, FPGA or IP Block design along with a matching application-specific software development kit (SDK) including all the necessary firmware, enabling a customer's applications to run on a cost-effective, power efficient, custom hardware platform.

In one implementation, all circuit blocks are designed from scratch using advanced design tools that are compatible with all industry standards, resulting in IP that will be completely owned by the customer. There is no need to license any third-party IP cores or pay any royalties. Customers who wish to use any third-party particular IP that they are familiar with, however, can also be accommodated by the system design flow. The power-aware architecture achieves significantly lower power and smaller die sizes than customizable IP solutions from others. And at each step during the C-code to GDSII translation process, the customer is given the opportunity to what-if different implementation choices for both architectural features and the semiconductor processes to be used. The system provides customers with first-time-right SoCs, ASICs, FPGAs or IP Blocks that meet all performance, power and cost constraints, while providing the industry's shortest time-to-market. The system can uniquely partition a customer's C-code into optimized modules that generate all the hardware and matched software components required for a complete solution. The system provides the customer with all the hardware, firmware and application-development software tools they need to realize their design, reducing drastically the development time and thus the time-to-market for developed products. By leveraging the system's advanced development process, customers can cut their time-to-market by a factor of two or three, compared to the combined hardware and software efforts required for a traditional design approach which can quickly balloon into man-years. In addition, the system's design methodology virtually guarantees a finished product that is first-time-right.

In the embodiment of FIG. 8, the customer deliver a working model of the application, coded in a C language algorithm, plus a comprehensive set of test stimulus vectors that exemplify all the application's functions. This master source code file, or the “Algorithm C-Code,” can make use of the complete ANSI C language syntax including all the standard dynamic memory allocation library functions such as malloc, realloc, calloc and free. An example of such an “Algorithm C-Code” is shown next in the Sample C code for a H.264 codec, which customers can upgrade at any time during the development process to accommodate different parameters or to enhance performance. These C-code algorithms, plus the complete test stimulus vector library, comprise the formal description of the algorithm (these test stimulus vectors are guaranteed in the final chip).

To guide with hardware implantation decisions, a customer also provides System Specification information separately from the Algorithmic C-code. Such information provides a real-time budget, latency and throughput requirements and other hardware specific needs such as system clocks, power supplies and input/output (I/O) requirements. These also include desired fabrication process node, testability features etc. From the Algorithmic C-Code, Test Vectors and the System Specification, Algotochip generates a complete description of the customer's application that never has to be done over again from scratch. Incremental changes, such as fixing a bug or adding a new feature, can be accommodated without having to redo finished modules. Most updates to a design can be accomplished by merely upgrading the C-code module describing it.

Example: H.264/AVC Reference Code

```
int main(int argc, char **argv)
{
  init_time( );
#if MEMORY_DEBUG
  _CrtSetDbgFlag ( _CRTDBG_ALLOC_MEM_DF |
  _CRTDBG_LEAK_CHECK_DF ); #endif
  alloc_encoder(&p_Enc);
  Configure (p_Enc->p_Vid, p_Enc->p_Inp, argc, argv);
  // init encoder
  init_encoder(p_Enc->p_Vid, p_Enc->p_Inp);
  // encode sequence
  encode_sequence(p_Enc->p_Vid, p_Enc->p_Inp);
  // terminate sequence
  free_encoder_memory(p_Enc->p_Vid, p_Enc->p_Inp);
  free_params (p_Enc->p_Inp);
  free_encoder(p_Enc);
  return 0;
}
```

The system does not require the customer to write any cycle-level C-code, just the behavioral level description without attempting to model any timing information. Customers do not have to drill down to the level of timing, because the system resolves these timing issues by making partition-level changes to the system architecture.

The customer's C-code is entirely algorithmic, and need not address any of the difficult-to-model timing and real-time performance characteristics. If needed, a custom engineering team can work directly with the customer's design team to meet all performance requirements with its system architecture.

The customer's algorithmic C-code is completely sequential, freed from the need to specify which modules should run on programmable micro-controllers or DSPs, non-programmable logic or other types of functional blocks. The customer's C-code can be completely agnostic with regard to the underlying hardware platform, with the system's tools and development efforts meeting all timing and performance specifications.

Customers do not even have to specify the real time performance requirements ahead of time. Instead, during the first few weeks of the design process, engineers can query the customer for the specific performance characteristics that need to be met as they relate to specific circuitry blocks.

FIG. 9 shows more details the system of FIG. 8. Customer code 902, test stimulus 912, and system specification 908 are supplied to a partitioner 910 that partitions the code into hardware or software modules and it may require hardware accelerators 1 and 2 (HA1 and HA2). The output of partitioner 910 is provided to an architecture generator 920 that determines peripherals such as interrupt unit 922, peripheral 924, DMA engine 926, and specialized accelerators HA 930-932. Information is then transferred to a representation by a SAMA (specification of architecture and micro-architecture) unit 940 that takes into consideration the hardware/software architecture 952, DMA and peripheral architecture 954, and memory architecture 956, along with physical design feedback estimators 958, among others. The estimators can provide timing, floor plan, power, and area estimation, for example. The architecture based on the C code is used to generate SDK 944 that includes compiler, linker and assembler, which is used to generate firmware 946. The SAMA 940 in turn generates a software development kit (SDK) 942 including compiler/linker/assembler and firmware generator. The SAMA 940 also generates a cycle accurate model 944 of the IC. In addition, using generators 946 that includes programmable and non-programmable RTL generators and DMA/arbitration RTL generators, the system generates an RTL/GDSII output 948 that is used to fabricate a custom chip 970. The SDK 942 in turn generates software 968 that can be used to program or otherwise develop software for the new custom chip.

The system of FIG. 9 first determines the architecture that will be required to implement the customer's algorithm as either a completely Programmable Solution, as a completely Non-Programmable Solution, or as a Hybrid Solution having Programmable and Non-Programmable elements. The Programmable Solution (including RTL, GDSII, SDK and Firmware) is completely generated and optimized for the customer's application. Since the programmable solutions are built up completely from scratch, they are immensely more efficient in silicon real estate and power consumption when compared with customizable IP blocks. However, the programmable architectures can also make use of a customer's chosen IP in its programmable solution, if so desired, such as to accommodate a particular processor core family or DSP architecture that is preferred or familiar to a customer.

For applications where a programmable solution alone cannot meet the customer's system specifications, it may be necessary to implement part of the algorithm with a hardware accelerator. The system identifies the code modules that can benefit from such hardware acceleration (HA). In this case, the Algorithmic C-code is modified by inserting separate C-code modules describing each hardware accelerator (HA) block. The Algorithmic C-code is subsequently referred to as hardware/software “HW/SW” Partitioned C-code, but is functionally equivalent to the original customer Algorithm C-Code. HW/SW Partitioned C-code can be executed with the same results as the customer's original C-code. The HA interface (HA i/f) passes parameters (by reference or by value), flow control and return-value locations. Intelligent flow control logic continues execution of the main block of programmable hardware until halted by dependencies on results still being calculated by a HA. In normal customer-developed SoC methodologies, customers do the partitioning of algorithms into hardware and software blocks manually with resulting high expense and long development cycle, but the system automatically performs this function for the customer. The resultant modified HW/SW Partitioned C-code runs on the system's programmable logic using an embedded microcontroller or DSP which automatically activates and synchronizes with as many HAs as are needed for an application.

The following example shows the same sample C code before and after Hardware/Software Partitioning. Here PartitionMotionSearch function is modified to use a hardware accelerator. Addresses for function call parameters (currMB, mode etc) are stored in an array (par_loc). The HA is utilized by calling a function_A2C_start_ha with parameter location (par_loc).

| Example: H.264/AVC Reference Algorithm C code | Example: H.264/AVC HW/SW Partitioned C code |
|---|---|
| if (enc_mb.valid[mode]) | _A2C_D_20433 = enc_mb.valid[_A2C_mode_630]; |
| { | if (_A2C_D_20433 != 0) |
| for (cost=0, block=0; block<(mode==1?1:2); block++) | { |
| { | cost = 0; |
| update_lambda_costs(currMB, &enc_mb, lambda_mf); | block = 0; |
| PartitionMotionSearch (currMB, mode, block, lambda_mf); | goto _A2C_D_20381; |
| | _A2C_D_20380:; |
| | update_lambda_costs (currMB, &enc_mb, lambda_mf); |
| | /* PartitionMotionSearch (currMB, mode, block, lambda_mf); |
| | */ |
| | par_loc[0] = &currMB; |
| | par_loc[1] = &mode; |
| | par_loc[2] = &block; |
| | par_loc[3] = &lambda_mf; |
| | ret_loc = 0; |

In addition to HW/SW partitioning, the system of FIG. 9 will also introduce system-level components, such as DMA, peripherals and configuration registers, into their C-code—called “Architecture C-code”—based on the system specifications provided by the customer. For example, stimulus in the algorithmic C-code might read from a file using “fopen,” which the system may translate into Architectural C-code for a DMA engine that fetches data from an A/D or SerDes and stores it in a specific memory location, then sets an interrupt to indicate the frame/buffer where the data is available in memory. Other architecture C-code added to the algorithmic C-code during HW/SW partitioning includes interrupt service routines, software models for peripherals, register interactions and other routines as required to completely describe all aspects of a design. This exemplary final Architecture C-code is still fully behavioral ANSI C compatible code that is functionally equivalent to the Algorithmic C-code and which can be executed on any platform, with appropriate modifications for DMA, interrupts, and other specific hardware features, as shown in the table below with the sample of C-code:

| Example: H.264/AVC Reference Code | Example: H.264/AVC Architecture C code |
|---|---|
| if([f=fopen(p_Inp->LeakyBucketRateFile, “r”]) == NULL) | _A2C_D_42363 = &p_Inp->LeakyBucketRateFile[0]; |
| { | /* _A2C_f_1882 = fopen (_A2C_D_42363, &“r”[0]); |
| printf(“LeakyBucketRate File does not exist. | */ |
| Using rate calculated from avg. rate \n”); return 0; | _A2C_init_Peripheral_Port[0]; |
| } | f = _A2C_f_1882; |
| for[l=0; i<NumberLeakyBuckets; i++] | if (f == 0) |
| { | { |
| if[1 != fscanf\|f, “%lu”, &buf)) | _builtin_puts (&“ LeakyBucketRate File does not exist. Using rate |
| | calculated from avg. rate ”[0]); |
| | _A2C_D_42365 = 0; |
| | return _A2C_D_42365; |
| | } |
| | else |
| | { |
| | } |
| | i = 0; |
| | goto _A2C_D_42361; |
| | _A2C_D_42360:; |
| | /* _A2C_D_42366 = fscanf (f, & “%lu”[0], &buf); |
| | */ |
| | _A2C_D_42366 = _A2C_read_Peripheral_{—} |
| | Port (O,NULL, (void*) &(buf)); |

The above sample shows the code before and after inserting peripherals. Here the fscanf syscall in the Algorithmic C-code is replaced with a Peripheral Port routine in the Architectural C-code.

Peripherals and other system-level components added to the Architecture C-code require cycle-accurate modeling (to at least the interface level) in order to make sure that Algotochip's design implements the full cycle-accurate model for the final chip. All system introduced hardware including the DMA engine, Memory Management Unit (MMU), arbitration logic and similar system components will include cycle-accurate simulation models. For non-system designed peripherals specified by the customer to be integrated on the chip, a cycle-accurate simulation model would also be required.

Once the Architecture C-code is complete, it serves as the starting point from which to generate the Architecture Definition of the targeted device. From this architectural description, The system develops the RTL/GDSII to build the actual hardware along with a software development kit (SDK) including a C-compiler, linker, debugger and assembler. The system also provides a complete cycle-accurate C++ model for the entire solution.

Using the generated SDK, this C-code can be compiled to create the necessary firmware that runs on the target programmable solution. The SDK includes the compiler, assembler and linker that creates an optimized binary image to run on this custom programmable solution

In cases where the customer requires specific IP blocks with which they are already familiar, such as a specific processor core, DSP, or system peripheral, the firmware generated from the Architectural C-Code will be compiled using the SDK from the processor, DSP or peripheral vendor.

The system of FIGS. 8-9 encompasses all the steps between submission by the customer of Algorithmic C-code to the creation of complete custom chip from the code almost without human handholding. Of importance to the customer is that a complete hardware/software/firmware solution is delivered—including the on-chip firmware—all generated on schedule, a capability that virtually guarantees that the customer's chip will be correct the first time.

To ensure a first-time-right design, the customer's design team uses the system to determine all the performance specifications that must be met by the chip. A preliminary questionnaire will ask for all pertinent performance metrics, such as throughput and latency needs, and will serve as a basis for hardware/software partitioning and other architectural decisions. Within a few weeks after providing initial information, the system will provide the customer with complete documentation describing the necessary system architecture. These provided documents are the same ones that the customer's own internal hardware design team would have supplied if it were designing the chip itself. All the details regarding just how the entire system will be structured are documented in an easy to read and understand format.

This documentation will describe all the details regarding how data comes into and flows out of the customer's proposed chip. Even though the customer's Algorithmic C-code contained no timing-level information, the documentation of the proposed system architecture will include all these details, including where data will be stored (in registers, stacks, queues or shared memory) how it will be transferred (using polling, interrupts, hand-shaking or DMA)—and how the data will flow into the chip, from subsystem to subsystem on the chip, and off the chip.

The system guarantees that this architecture meets all the performance specifications set by the customer in their initial questionnaire. However, at any point the customer can also specify that performance cushions be included in order to accommodate planned upgrades, or to anticipate adding future features that are planned but not yet designed. At this point, the system's architectural features are modified to accommodate the performance cushions, then provide revised documentation which will again be guaranteed to meet all final performance specifications. At any time during the design process, the customer can make special requests for specific types of memory, I/O protocols, microcontroller cores, process design kits (PDKs), or software compliers. The system is completely agnostic on all these issues, which will be accommodated unconditionally.

Once the customer is satisfied with this documentation, the system will supply a traditional sign-off checklist including all the necessary timing level reports for the architectural features in your system. Checklists include a stack timing report; a fault analysis report and any other sign-off check lists required by your design team, guaranteeing that all aspects of the finished design are first-time right. The system will then prepare the customer's design for a specific foundry, fully documenting the trade-offs in cost, chip size and power consumption for different process options. The system is completely agnostic regarding the various processes offered by different foundries. The system uses industry standard CAD tools to implement a physical design, thus insuring proper design flows, and provides a sign-off physical design checklist similar to traditional flows. Once the customer signs off on this specific foundry process, The system will work directly with the foundry right up to delivery of the customers finished chips.

The system alleviates the problems of chip design and makes it a simple process. The embodiments shift the focus of product development process back from the hardware implementation process back to product specification and computer readable code or algorithm design. Instead of being tied down to specific hardware choices, the computer readable code or algorithm can always be implemented on a processor that is optimized specifically for that application. The preferred embodiment generates an optimized processor automatically along with all the associated software tools and firmware applications. This process can be done in a matter of days instead of years as is conventional. The system is a complete shift in paradigm in the way hardware chip solutions are designed. Of the many benefits, the three benefits of using the preferred embodiment of the system include
1) Schedule: If chip design cycles become measured in weeks instead of years, the user can penetrate rapidly changing markets by bringing products quickly to the market; and
2) Cost: The numerous engineers that are usually needed to be employed to implement chips are made redundant. This brings about tremendous cost savings to the companies using system.
3) Optimality: The chips designed using The instant system product have superior performance, Area and Power consumption.

By way of example, a computer to support the automated chip design system is discussed next. The computer preferably includes a processor, random access memory (RAM), a program memory (preferably a writable read-only memory (ROM) such as a flash ROM) and an input/output (I/O) controller coupled by a CPU bus. The computer may optionally include a hard drive controller which is coupled to a hard disk and CPU bus. Hard disk may be used for storing application programs, such as the present invention, and data. Alternatively, application programs may be stored in RAM or ROM. I/O controller is coupled by means of an I/O bus to an I/O interface. I/O interface receives and transmits data in analog or digital form over communication links such as a serial link, local area network, wireless link, and parallel link. Optionally, a display, a keyboard and a pointing device (mouse) may also be connected to I/O bus. Alternatively, separate connections (separate buses) may be used for I/O interface, display, keyboard and pointing device. Programmable processing system may be preprogrammed or it may be programmed (and reprogrammed) by downloading a program from another source (e.g., a floppy disk, CD-ROM, or another computer).

Each computer program is tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

The invention has been described herein in considerable detail in order to comply with the patent Statutes and to provide those skilled in the art with the information needed to apply the novel principles and to construct and use such specialized components as are required. However, it is to be understood that the invention can be carried out by specifically different equipment and devices, and that various modifications, both as to the equipment details and operating procedures, can be accomplished without departing from the scope of the invention itself.

What is claimed is:

1. A method to automatically design a custom integrated circuit, comprising:
automatically generating a computer architecture from a specification of the custom integrated circuit including computer readable code and one or more constraints on the custom integrated circuit, wherein the computer architecture includes at least one of: programmable processor, co-processor, programmable specialized accelerator, non-programmable specialized accelerator, memory management logic, DMA and peripherals;
automatically generate computer readable code to run on the computer architecture;
automatically determining an instruction execution sequence based on the code profile and reassigning or delaying the instruction sequence to spread operation over one or more processing blocks to reduce hot spots;
iteratively evaluating and optimizing one or more factors including physical implementation, and local and global area, timing, or power at an architecture level above RTL or gate-level synthesis;
automatically generating a software development kit (SDK) and the associated firmware automatically to execute the computer readable code on the custom integrated circuit;
automatically generating associated test suites and vectors for the computer readable code on the custom integrated circuit; and
automatically synthesizing the designed architecture and generating a computer readable description of the custom integrated circuit for semiconductor fabrication.

2. The method of claim 1, comprising performing static profiling of the computer readable code.

3. The method of claim 1, comprising performing dynamic profiling of the computer readable code.

4. The method of claim 1, comprising selecting an architecture based on the computer readable code.

5. The method of claim 1, comprising optimizing the architecture based on static and dynamic profiling of the computer readable code.

6. The method of claim 1, comprising compiling the computer readable code into assembly code.

7. The method of claim 7, comprising linking the assembly code to generate firmware for the selected architecture.

8. The method of claim 7, comprising performing cycle accurate simulation of the firmware.

9. The method of claim 7, comprising performing dynamic profiling of the firmware.

10. The method of claim 9, comprising optimizing the architecture based on profiled firmware.

11. The method of claim 7, comprising optimizing the architecture based on the assembly code.

12. The method of claim 1, comprising generating register transfer level code for the selected architecture.

13. The method of claim 12, comprising performing synthesis of the RTL code.

14. A system to automatically design a custom integrated circuit, comprising:
a. means for receiving a specification of the custom integrated circuit including computer readable code and one or more constraints on the custom integrated circuit;
b. means for automatically generating a computer architecture with programmable processor and one or more co-processors for the computer readable code that best fits the constraints;
c. means for automatically determining an instruction execution sequence based on the code profile and reassigning or delaying the instruction sequence to spread operation over one or more processing blocks to reduce hot spots;
d. means for continuously evaluating and optimizing one or more factors including physical implementation, and local and global area, timing, or power at an architecture level above RTL or gate-level synthesis;
e. means for automatically generating a software development kit (SDK) and the associated firmware automatically to execute the computer readable code on the custom integrated circuit;
f. means for automatically generating associated test suites and vectors for the computer readable code on the custom integrated circuit; and
g. means for automatically synthesizing the designed architecture and generating a computer readable description of the custom integrated circuit for semiconductor fabrication.

15. The system of claim 14, comprising means for performing static and dynamic profiling of the computer readable code.

16. The system of claim 14, comprising means for selecting an architecture based on the computer readable code.

17. The system of claim 14, comprising means for optimizing the architecture based on profiles of the computer readable code.

18. The system of claim 14, comprising a compiler to convert the computer readable code into assembly code.

19. The system of claim 14, comprising a cycle accurate simulator to test the firmware.

20. The system of claim 14, comprising register transfer level code generator for the selected architecture.
